(19) United States
(12) Patent Application Publication
(10) Pub. No.: US 2007/0086514 A1
(43) Pub. Date: Apr. 19, 2007

(54) Integrated power supply and communication device

(75) Inventor: Micah T. Lawrence, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/251,116

(22) Filed: Oct. 13, 2005

(51) Int. Cl. H04L 5/16

(52) U.S. Cl. 375/219

(57) ABSTRACT

An integrated power supply and communication device is presented. The integrated device provides power and communication access to an electronic appliance. The integrated device may be manufactured with a single power and communication input, reducing the amount of wiring and cabling often present with conventional modems. A plurality of electronic appliances can be networked over an existing power line communication (PLC) network. By using low and speed communication modules, more advanced electronic appliances can communicate with less sophisticated electronic appliances. The integrated device also allows access to other networks, such as a bridged network. The bridged network may then provide access to other, local area networks (LAN), local power networks, and the World Wide Web. The integrated device can be programmed and configured to be adapted to many different electronic devices, allowing user flexibility in setting up a PLC network.

### BACKGROUND

1. Field of Invention

The present invention relates to the field of power line communication, and specifically to an integrated power supply and communication device.

2. Description of Related Art

Ethernet technology has become a standard for high speed data communications due to its cheap cost, availability, and overall simplicity. Unfortunately, this wired technology requires a significant infrastructure of cabling to link up even a household, much less an office building. Installation during construction minimizes the overall impact, but installation in existing structures can be very costly and inefficient. Wifi, or the 802.11x protocol, has offered an alternative for short-range applications, but it still relies on a wired infrastructure for any reasonable range. Additionally, signal strength varies based on location and obstructions between the host and the access point. Power Line Communications (PLC) offers a hybrid approach to this problem as it presents a communication link that is ubiquitous in nearly any pre-existing structure, and does not face the fading signal issues faced by Wifi. Certainly, PLC has many challenges of its own, but recent research has proven that they do not detract from the overall usability and speed of this technology.

Although PLC is not a new technology, only recently has it has shown itself to be a potential competitor to other networking topologies such as Ethernet. Previously, significant noise frequently present in power lines rendered high speed protocols almost impossible, but the emergence of Orthogonal Frequency Division Multiplexing (OFDM) and advanced coding techniques have given power lines the opportunity to catch up to speeds of other topologies. One example of the advances in PLC technology employing OFDM can be seen in the Intellon 6000 chip (available from Intellon Corporation, Ocala, Fla., USA). This chip is capable of speeds up to 100 Mbps over power lines. The ability to network at this speed over an existing infrastructure present in every building gives rise to many possibilities related to its use.

Currently, the only devices known to exist that incorporate PLC are stand alone units that plug into an existing power outlet, and provide an Ethernet connection to be used by a PC or other device that uses this connection. However, the future is likely to bring many “smart” electronics that use networking to communicate and naturally need power to operate. The ability to mesh the PLC capability with traditional power supplies would allow many appliances and other electronics to be “plug and play” capable, while at the same time using minimal hardware and power outlets.

Therefore, an integrated power supply and communication device is presented that provides power as well communication capabilities while minimizing power and communication inputs.

### SUMMARY

An integrated power supply and communication device is described. The integrated communication device receives a power and communication input and distributes the input into a communication module and a voltage converter. By integrating power and communication inputs into one device, the amount of inputs (e.g., physical wires and connectors) inflowing into an electronic appliance is minimized. In addition, many other benefits of the integrated communication device may be utilized.

One embodiment of the integrated communication device allows many different types of appliances to communicate with each other. In this embodiment, high speed and low speed communication modules are embedded in the communication device. The high speed communication module allows electronic appliances such as a computer to communicate with other computers over a local Power Line Communication (PLC) network. The high speed communication module may also be used to communicate over the Internet or with other networks via a bridged network. The low speed communication modules allow for simple data transfer between electronic appliances such as a coffee maker and a microwave. By use of a controller, also embedded in the integrated communication device, a device that uses high speed communication can also communicate with electronic appliances that use low speed communication modules and vice versa.

Another embodiment of the present invention utilizes configuring the embedded controller to perform programmed or user defined functions. For example, the controller can be configured to control the voltage converter with the communication device.

These as well as other aspects and advantages of the present invention will become apparent to those of ordinary skill in the art by reading the following detailed description, with appropriate reference to the accompanying drawings.

### BRIEF DESCRIPTION OF THE DRAWINGS

FIG. 1 is a block diagram showing an integrated power supply and communication device in accordance with one embodiment of the present invention;

FIG. 2 is a block diagram of an integrated power supply and communication device in accordance with a second embodiment of the present invention; and

FIG. 3 is a block diagram illustrating several applications of the second embodiment of the present invention.

### DETAILED DESCRIPTION

In many of the electronic devices in use today, the number of inputs and outputs that these devices have can often be quite numerous. A computer, for example, may receive an AC power input, an Ethernet connection or several USB connections (e.g., for a printer, camera, or other media device). In addition, fire wire, may be input for high speed communication from a video camera or a personal music player. Not to mention, other inputs and outputs that may be connected to a computer, such as a microphone input, speaker output or serial or parallel port connections (e.g., a mouse or a keyboard). Needless to say, the list of inputs for a given electronic device may be quite extensive. In order to minimize the number of inputs into an electronic device, an integrated power and communication device is presented.

The integrated communication device presented in this disclosure acts as a communication transceiver by not only supplying a user, or more appropriately an electronic appliance, with AC or DC supply voltages but it also supplies high and/or low speed communication access via one external power connection. That is, the integrated communication device distributes an incoming power and communication input into output voltage and communication components. Other benefits of this device may include power output control by way of a controller embedded in the integrated communication device and accessibility of electronic appliances over existing local and foreign power distribution networks.

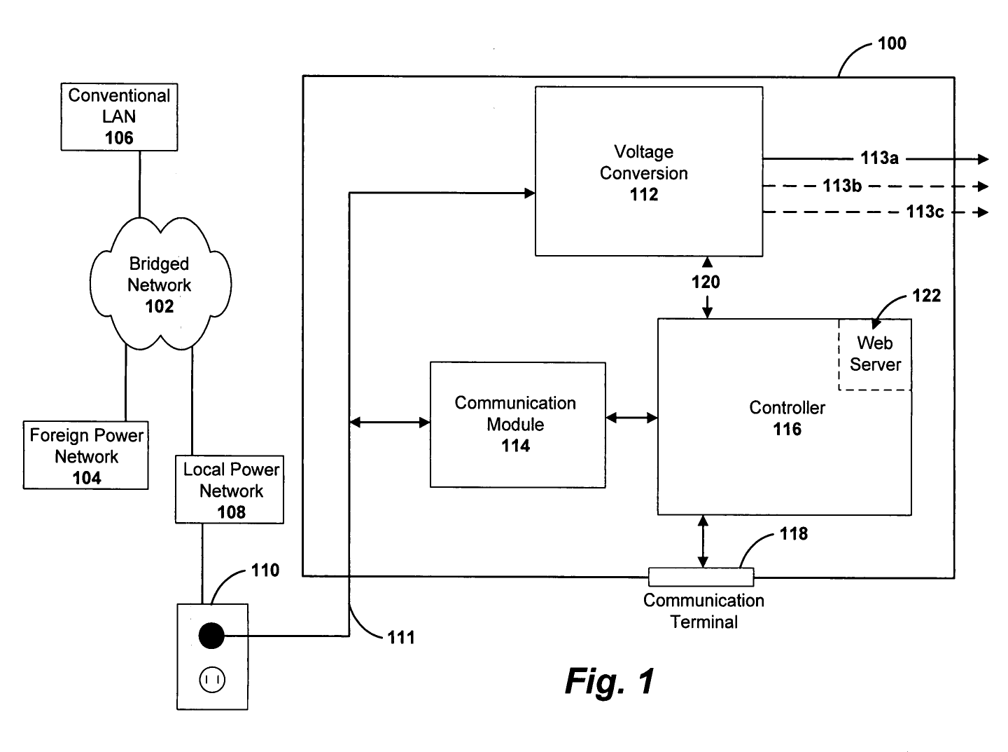

Turning now to FIG. 1, a block diagram illustrates an integrated power supply and communication device 100. Foreign communication transmissions may be received from a bridged network 102, where the source of the communication may be another network, such as network 104 or network 106, or the Internet. In each instance of a power network connecting to the bridged network, such as local power network 108, wall outlets may be used, such as a standard wall outlet 110, to distribute the connection. Local power network 108 may comprise the infrastructure of power lines and other conduits for supplying power that are found in residential or commercial buildings. Much of the detail of power line communication (PLC) and its protocol already exist. As discussed above, with the advent of OFDM, companies such as Intellon and others have continued to increases the speed and feasibility of PLC technology.

As described above, the local power network 108 is accessed by the integrated communication device 100 at a standard wall outlet 110. Similar to the infrastructure of the local power network 108, the standard wall outlet 110 may be any type of power access found in residential or commercial buildings. In this embodiment, the integrated communication device is connected to a power and communication input 111 via a standard connection into the outlet 110. The integrated communication device can receive a variety of available power types, such as standard 110V or 220V 60 Hz power supplies.

Depending on the configuration, the integrated communication device 100 may be integrated into an appliance, such as a PC, microwave, TV, or refrigerator, for example. The integrated communication device 100 may provide the specific power requirements of the appliance, be it AC or DC, or some combination of the two. Alternatively, the integrated communication device may be a stand-alone configurable power supply with communication capability that could control appliances that have been manufactured without power line communication technology.

Once the power and foreign communication transmission is inside the integrated communication device 100, it is distributed to a voltage converter 112 and a communication module 114. The voltage converter 112 can be a transformer or converter that can provide one or more AC or DC output voltages 113a. The voltage converter can provide a plurality of voltages such as 113b and 113c. Accordingly, the output voltages could provide power to a number of components within an electronic appliance. For example, one output voltage could be an AC voltage source for a lamp within an electronic appliance. A DC output could power a clock within the same electronic appliance. The voltage converter can also be configured to provide power for the DC power or logic of the communication module 114 or the controller 116. Or, the voltage converter may be bypassed and the input and output voltages could be identical.

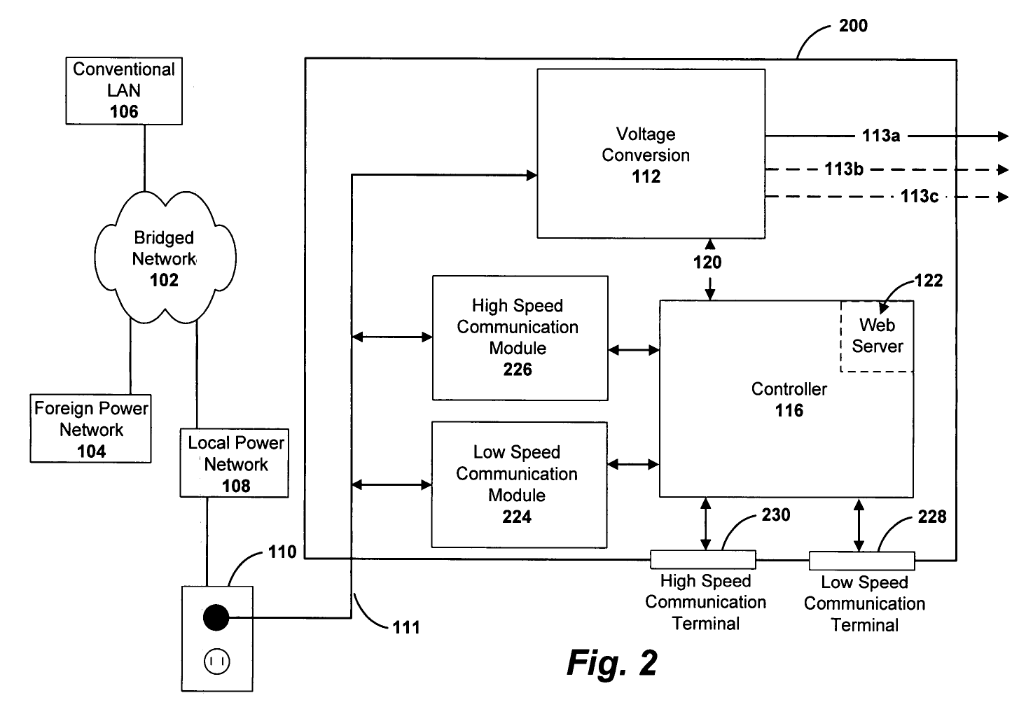

The communication module 114 is a power line communication device. As mentioned above, one such device is the INT6000CS offered by Intellon. Low speed communication devices could be implemented as well. Chipsets such as the AN48 and the AN 192 (available from Adaptive Networks Inc., Newton, Mass., USA) offer lower speeds communications at 4.8 Kbps and 19.2 Kbps respectively. For example, a timer in a microwave oven could communicate via low speed communication with an audible alarm plugged into the local power network 108 in another location. Because the signal triggering an alarm is not particularly complex, high speed communication may not be necessary. It may also be advantageous to have both high and low speed communication modules within an integrated communication device. An embodiment of one such device incorporating both high and low speed communication modules is described in further detail with reference to FIG. 2.

After the communication module 114 receives a transmission over the local power network, the transmission is sent to the controller 116. The controller itself may be manufactured as an integrated circuit which is stand alone or it may be integrated into the communication module 114 or the voltage conversions module 112. The controller 116 alternatively may be a conventional microcontroller. The design and implementation of the microcontroller may depend considerably on the cost of manufacturing the integrated communication device 100, and may be application-specific.

Once the controller 116 receives a signal from the communication module 114, it can process the signal. Processing the signal includes adjusting the output voltages, replying with a status message or requested telemetry and relaying the signal to a communication terminal 118 where an electronic appliance can interface the controller.

An outgoing signal can also be sent from an electronic appliance via the communication terminal 118 to the controller 116. The controller 116 can then process the signal sent from the electronic appliance. Again, processing includes relaying the signal from the electronic appliance to the communication module 114 as well as a variety of other functions typically provided by a conventional controller.

Once the outgoing signal is sent to the communication module 114 it can then be sent by way of the communication module 114 to the local power network 108. The signal sent from the electronic appliance can then be exchanged with other devices on the local power network 108, and ultimately out to bridged network 102 and the Internet.

Other features that may be implemented with the controller 116 are control of the voltage converter 112 as well as an embedded web server 122 which would allow direct control of the controller 116 by the use of external software applications. Control of the voltage converter 112 could simply be a communication link 120 between the controller 116 and the voltage converter 112. An external software application could use the web server 122 to control the voltage converter 112 via the controller 116. These applications could also be used to initially configure the integrated communication device 100 for use, similar to setting up a new network connection on a LAN using a router interface. The web server 122 may also report status information. Status information may include the status of the voltage converter 112. Other status could include a list of all available appliances on the local power network 108.

The web server 122 may also allow the user to control the appliance as dictated by the specific allowable control features of that appliance. Each appliance may have a certain number of implemented features that are controllable by means such as a relay in the voltage converter 112, for example. Alternatively, an appliance may be manufactured with a custom control interface so that a user may adjust or setup the integrated communication device 100 remotely as well as locally. For example, a user may use the control interface so as to set the brightness level of a table lamp or the control interface may be used in a coffee maker to set the time at which a pot of coffee is to be brewed. The control interface may allow a user the ability to monitor and control devices simultaneously without physically being in the vicinity of the devices. The control interface may also list the available functions that can be programmed for a given appliance.

The above implemented features may be set by a consumer or an appliance manufacturer. In terms of manufacturing, the device can be prefabricated and added to an existing manufactured product. For example, the integrated communication device 100 could be prefabricated as a television power and communication device. The voltage converter 112 could be a transformer that powers the television. The communication module 114 could relay television signals on a bridged network 102 to the controller 116. The communication terminal 118 could be a coaxial cable output that could be wired to an existing coaxial cable input on a television. By removing the standard power transformer from a television and connecting AC and DC output power terminals 113a-c to AC and DC components within the television, a television manufacturer could upgrade their product line by adding the integrated communication device 100 to their assembly line. Only minimal adjustment to the circuit boards and logic within the television may be required to accommodate the integrated communication device 100.

In some electronic appliances, it may be useful to have more than one mode of communication. It may be desirable to have low speed and high speed communication capabilities, for example. FIG. 2 illustrates an integrated power supply and communications device 200 that is capable of communicating from the controller 116 via a low speed communication module 224 and a high speed communication module 226. The low speed and high speed communication modules 224, 226 are connected to the controller 116. The controller 116 has two communication terminals, 228, 230, for a low speed and a high speed, respectively. Either of these two terminals can be connected to an electronic appliance. One of the advantages of having low speed and high speed communication terminals 228, 230 and modules 224, 226 is the ability able to manufacture a universal integrated communication device. An integrated communication device 200 could be used for one application and then if the user or manufacturer decided that the device 200 should be used elsewhere, it could be reprogrammed and used with a different electronic appliance.

Another advantage of having high and low speed communication modules is the ability to have one interface for slow speed control signaling, and the other for high speed data transfer. Many appliances that use PLC technology send control signals at low speeds (e.g., up to speeds of about 30 kb/s). Data transfer, however, occurs at much higher speeds (e.g., speeds of about 300 kb/s and up). Additionally, in contrast to control signals, data transfer may also occur between different networks via a bridged network, such as bridged network 102. For example, the high speed communication module may include or be coupled with an Ethernet adapter so that the integrated communication device 200 may have access to the Internet via bridged network 102.

Having high and low speed communication modules available on an integrated communication device 200, allows an appliance to accommodate other appliances and network elements, and not be limited to only one type or speed of communication. The high speed data communication module 226 might be used by a TV, for example, to compile a list of all programs watched in the past week, sorted by genre, so parents can monitor the programs that their kids watch. The low speed communication module 224 could be used by the same T.V. to adjust the lighting in the room or send an alert that the popcorn in the microwave is ready.

Another example of an application using integrated communication device 200 is in a modern refrigerator. Some modern refrigerators have bar scanners that allow an inventory of the items in the refrigerator to be kept. An e-mail containing the contents of the refrigerator could be sent via the high speed communication module 226 upon user request or at a specific time. Assuming items are scanned out when they are gone (i.e. milk), the user can use the inventory list to determine what items need to be purchased. The low speed communication module 224 could communicate with appliances on the local power network 108. Using the low speed communication module 224, the refrigerator could provide such features as synchronizing clocks on the local network 108, or notifying a user when a pot of coffee is brewed. The refrigerator could also send an alert to a local alarm system, via either communication module 224 or 226 that the refrigerator door has been left open, or a water filter needs to be changed.

A manufacturer that sells both televisions and other household appliances could buy the integrated communication devices 200 from a supplier and use them interchangeably in different appliances. The voltage conversion unit module 112 could have several available transformers. If the controller 116 has a web server 122 embedded within it or if the controller 116 is programmable remotely by other means such as a serial link, the controller 116 could select the appropriate transformer to use, determine the address and identification of the integrated communication device 200 (i.e., identification such a refrigerator model name or number), and determine the functions to be performed and allowed by the integrated communication device 200. The universal nature of the integrated communication device 200 creates potential cost savings by not limiting a user or manufacturer with only one application of the device 200. Depending on the application, multiple communication modules, such as two or more high speed or low speed communication modules 224, 226 could also be used.

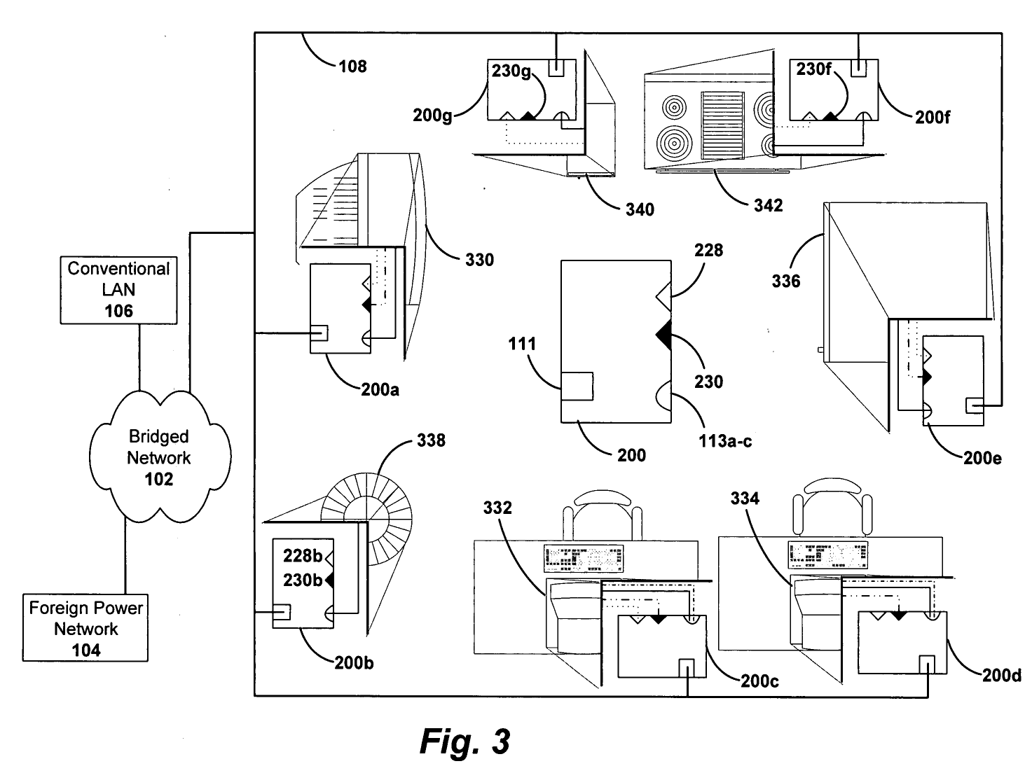

In order to illustrate networking appliances via the communication module, FIG. 3 illustrates a local power network 108 employing electronic appliances using the integrated communication devices 200a-g. The external connections of the input power and communication 111, output AC or DC power 113a-c, low speed communication terminal 228, and high speed communication terminal 230 are all labeled on the integrated communication device 200. As discussed previously, the integrated communication device 200 may be designed with more than one low or high speed communication terminals 228, 230 and communication modules 224, 226. The low and high speed communication modules may be used for control signaling, data transfer, or both. In this illustration, a television 330 is connected to the local power network 108, through an integrated communication device 200a. Low speed communication is provided as well as high speed communication. Low speed communication may allow such functions as synchronization of an internal clock or on/off functionality of the voltage converter 212 by a signal sent from a computer 332 on the local network 108. High speed communication could also be relayed from the computer 332 or through a television broadcasting service.

Also illustrated in FIG. 3 are two computers 332 and 334 connected over the local power network 108 in the same manner as a conventional network. The computers 332 and 334 are shown with power outputs 113 that power more than one component within the computer. Computers 332, 334 may have a reduced number of inputs when compared to conventional input schemes. That is, if the integrated communication devices 200c, 200d are located within computers 332, 334, only one input may be used for power and communications. Connections such as Ethernet or modem may not be connected and thus, the number of inputs is reduced.

A plurality of computers can be linked to the local power network 108 in the same manner as computers 332, 334. Other appliances, such as a refrigerator 336, may also communicate over the local power network 108 via high speed communication.

Additionally, “simpler” electronic appliances using low speed communication over the local power network 108 are also illustrated. A table lamp 338 is shown connected to the output power of the integrated communication device 200b. Note that the high speed and low speed communication terminals 228b, 230b are not connected. Despite this, a communication module within integrated communication device 200b is still used to provide remote functionality. In most circumstances, the table lamp 338 will comprise “simple” circuitry that may not be able to communicate via communication terminals 228b, 230b. Regardless of the type of circuitry within the table lamp 338, the status (i.e., on or off or “dimmed”) could be relayed from the controller 116.

A coffee maker 340 and an oven 342 are also connected to the local power network 108 through an integrated communication device 200. In this illustration, the coffee maker 340 and the oven 342 communicate via low speed communication; however, if functions within the appliance can use high speed communications, they can be adapted by connecting a high speed component within the appliance to the high speed terminals 230f, 230g on the integrated communication devices 200f, 200g.

These other local networks could include residential houses, commercial buildings, or even a hotel room in a distant geographic location. If a user configures a local power network with permissions that allow foreign users to access electronic appliances on the local power network 108, it is quite possible that many common appliances could be controlled from remote locations. By accessing the integrated communication device 200 over the bridged network 102, a user located at network 104 (such as an office building) could program the coffee maker 340 to make a pot of coffee, turn on the table lamp 338, preheat the oven 342 and turn the television 330 to a desired station before the user arrived at the local power network 108.

Overall, the presented integrated power and communication devices provide a standalone plug and play or integrated solution for power supply and communication access. As discussed above, an integrated communication device allows a variety of different types of PLC communication ranging from low speed to high speed between various complexities of appliances. Power is also supplied from this integrated communication device, so many appliances may have a reduction in the number of wires or other input connections they receive. An embedded controller may also be used to provide additional functionality.

Embodiments of the present invention have been described above. Those skilled in the art will understand, however, that changes and modifications may be made to these embodiments without departing from the true scope and spirit of the present invention, which is defined by the claims.

I claim:

1. A communication transceiver for an electronic device, wherein the communication transceiver converts a first power received from a power line to a second power for powering the electronic device, and wherein the communication transceiver in operation transmits data from the electronic device to the power line and provides data received from the power line to the electronic device, thereby allowing the electronic device to communicate with a second device across the power line.

2. The device as in claim 1, wherein the communication transceiver is programmable to determine a type of conversion of the first power to the second power.

3. The device as in claim 1, wherein data received from the power line is used to determine the type of conversion of the first power to the second power.

4. The device as in claim 1, further comprising an embedded web server for programming the communication transceiver.

5. The device as in claim 1, wherein the communication transceiver comprises a low speed and a high speed communication module.

6. The device as in claim 5, wherein the low speed communication module transceives data at a rate of up to 30 kb/s.

7. The device as in claim 6, wherein the high speed communication module transceives data at a rate above 300 kb/s.

8. The device as in claim 5, wherein the electronic device includes a communication interface for coupling low speed and high speed data signals with the low and high speed communication modules.

9. The device as in claim 8, wherein data received from the communication interface is used to determine the type of conversion of the first power to the second power.

10. The device as in claim 5, wherein the electronic device is a computer.

11. A computer having a power supply connected by a single cord to an external power line, wherein the power supply includes circuitry for transceiving communication data across the external power line.

12. The device as in claim 11, wherein the computer includes a controller for controlling the type of power output from the power supply.

13. The device as in claim 11, wherein the computer includes a controller for controlling an amount of power output from the power supply.

14. The device as in claim 11, wherein the circuitry comprises low speed and high speed communication components so as to transceive the communication data over the external power line at low and high speeds.

15. The device as in claim 14, wherein the computer is part of a household appliance.

16. The device as in claim 14, wherein the computer is a personal computer.

17. The device as in claim 14, wherein the computer is a processing unit for an entertainment device.

18. A method of transceiving data to and from an electronic device, comprising:
receiving a first power from a power cord connected to a power line;
converting the first power to a second power for powering the electronic device;
receiving incoming communication data from the power cord connected to the power line; and
providing the incoming communication data to the electronic device.

19. The method off claim 18, further comprising:
receiving outgoing communication data from the electronic device; and
transmitting the outgoing communication data across the power cord to the power line, thereby allowing the electronic device to communicate with a second device across the power line.

20. The method of claim 18, further comprising:
receiving power adjustment data from the power cord connected to the power line; and
adjusting the second power to a power level determined by the power adjustment data.
